(19) United States
(12) Patent Application Publication
(10) Pub. No.: US 2003/0154937 A1
(43) Pub. Date: Aug. 21, 2003

(54) Method for determining an angle of crank arrangement in a multi-cylinder internal combustion engine and a multi-cylinder internal combustion engine using this method

(76) Inventors: Kuninori Ito, Yokohama (JP); Nobuaki Sato, Yokohama (JP)

Correspondence Address: WENDEROTH, LIND & PONACK, L.L.P., 2033 K STREET N. W., SUITE 800, WASHINGTON, DC, 20006-1021, US

(21) Appl. No.: 10/354,089

(22) Filed: Jan. 30, 2003

(30) Foreign Application Priority Data
Jan. 30, 2002 (JP) 2002-020985

(51) Int. Cl. F02B 75/22; F02B 75/20

(52) U.S. Cl. 123/54.8; 123/58.1

(57) ABSTRACT

In a multi-cylinder reciprocating internal combustion engine, an optimal angle of crank arrangement that reduces vibrating force caused in the engine is obtained.

Where Fₘ is the sum of an unbalanced force of order m that acts as vibrating force in the multi-cylinder reciprocating internal combustion engine (having the number of crank throws of n) and is represented by;

F₍ₘ₎=Fₘ[1 1 . . . 1][exp(im·α₁)exp(im·α₂) . . . exp(im·αₙ)]^{t}=Fₘ·gₘ and

|gₘ| is an absolute value of a non-dimensional coefficient of F₍ₘ₎ and is represented by;

|gₘ|=abs{[1 1 . . . 1][exp(im·α₁)exp(im·α₂) . . . exp(im·αₙ)]^{t}};

a restrictive condition is set in which |gₘ|is endlessly approached to zero, and where M₍ₖ₎ is an unbalanced couple that is expressed by the unbalanced force of order k of each crank throw, weighted by distance L between each cylinder, and is represented by;

M₍ₖ₎=FₖL[s₁ s₂ . . . sₙ][exp(ik·α₁)exp(ik·α₂) . . . exp(ik·αₙ)]^{t}=FₖL·fₖ and

|fₖ| is an absolute value of a non-dimensional coefficient of the unbalanced couple, that is obtained by M₍ₖ₎ being divided by FₖL, and is represented by;

|fₖ|=abs{[s₁ s₂ . . . sₙ][exp(ik·α₁)exp(ik·α₂) . . . exp(ik·αₙ)]^{t}};

an angle of the crank throw arrangement αⱼ (j=1, 2, . . . , n.) is obtained to be determined by an expression on an orthogonal coordinate system, the angle of the crank throw arrangement αⱼ minimizing, under the restrictive condition, the n-th power of |fₖ|, n being an even number.

### BACKGROUND OF THE INVENTION

1. Field of the Invention

The present invention generally relates to a method for determining an angle of crank arrangement in a multi-cylinder internal combustion engine and to a multi-cylinder internal combustion engine using this method. More particularly, the method is for determining the angle of the crank throw arrangement (ignition interval) of each cylinder in a multi-cylinder reciprocating internal combustion engine, that is most influential on the engine vibration, so that unbalanced couple acting as vibrating force becomes minimum. Also, the engine using this method is a multi-cylinder reciprocating internal combustion engine that has the angle of the crank throw arrangement determined so that the unbalanced couple becomes minimum. This engine includes a 4-stroke cycle in-line type 7 cylinder or V-type 14 cylinder internal combustion engine, a 4-stroke cycle in-line type 9 cylinder or V-type 18 cylinder internal combustion engine and a 2-stroke cycle in-line type 8 cylinder internal combustion engine.

2. Description of the Prior Art

The vibrating force that generates vibration in the reciprocating internal combustion engine includes unbalanced force, external couple, internal couple, torque variation, etc. and the vibration includes many kinds of vibration, such as vibration of the engine main body, torsional vibration of the crankshaft, etc.

In the multi-cylinder reciprocating internal combustion engine, the vibrating force is caused mainly by inertia force of moving portions in the internal combustion engine and explosion force in the cylinder. But, as the angle of the crank throw arrangement of each cylinder is changed, the direction of vibrating force changes in each of the cylinders. Hence, the vibrating force as a whole in the internal combustion engine is largely influenced by the angle of the crank throw arrangement.

The inventors here have heretofore studied to suppress within an allowable range the unbalanced force caused in the multi-cylinder reciprocating internal combustion engine that has the angle of the crank throw arrangement unequally spaced, and disclosed a method for determining the angle of the crank throw arrangement so as to obtain the optimal angle of the crank throw arrangement by which the vibrating force in question can be reduced to a necessary level regardless of the number of cylinders (the Japanese laid-open patent application No. 2001-65443).

That is, according to the abovementioned method, the angle of the crank throw arrangement in a multi-cylinder reciprocating internal combustion engine is determined as follows:

Where n is the number of cylinders, that is, the number of crank throws, the unbalanced force Fⱼ of order k of each cylinder is represented by:

Fⱼ=Fₖ·exp(iₖαⱼ)

(Here, Fₖ is a size of the unbalanced force of order k, i=(−1)^{1/2} and αⱼ is an angle of the crank throw arrangement of number j, j being 1, 2, . . . , n.)

The unbalanced force Fⱼ is weighted by distance L between each cylinder and added together, so that the unbalanced couple of order k, M₍ₖ₎, that acts as the vibrating force, is represented by:

M₍ₖ₎=FₖL[s₁ s₂ . . . sₙ][exp(ik·α₁)exp(ik·α2) . . . exp(ik·αₙ)]^{t}=FₖL·fₖ

wherein the unbalanced force of order m, F₍ₘ₎, is represented by:

F₍ₘ₎=Fₘ[1 1 . . . 1][exp(im·α₁)exp(im·α₂) . . . exp(im·αₙ)]^{t}=Fₘ·gₘ

(Here, m is the number or numbers of order or orders of the unbalanced force that is wanted to fall within an allowable range, that is, 1 and 2 for example. sⱼ means a non-dimensional coordinate in the crank axial direction of the crank throw of number j, represented by a plus or minus value from a reference crank throw, that is, sⱼ may be smaller than 0 (sⱼ<0). When the crank throw of number j is the reference crank throw, sⱼ equals 0 (sⱼ=0). t is a designation of a turned matrix.)

In the above equation, gₘ is a non-dimensional coefficient, that is represented by:

gₘ={[1 1 . . . 1][exp(im·α₁)exp(im·α₂) . . . exp(im·αₙ)]^{t}}

Under such a restrictive condition that the value of gm is to fall within the allowable value, a non-dimensional coefficient fₖ of the abovementioned unbalanced couple M₍ₘ₎, that is represented by;

fₖ={[s₁ s₂ . . . sₙ][exp(ik·α₁)exp(ik·α₂) . . . exp(ik·αₙ)]^{t}}

is minimized and thereby the angle of the crank arrangement αⱼ can be obtained. (As αⱼ is an angle of the relative arrangement between each cylinder, one thereof is fixed.)

On the other hand, not much attention has so far been paid to employing an internal combustion engine of 7 cylinders or 9 cylinders because of worries of occurrence of vibration due to the unbalanced force. Hence, such an uneconomical use of cylinders as 8 cylinders instead of 7 cylinders or 10 cylinders instead of 9 cylinders has been carried out.

Also, even in the engine of 8 cylinders, 10 cylinders or the like in which the vibration is relatively low, if a further lower vibration is required, it is needed to reduce the vibration by an additional device, such as a balancer.

Moreover, in a passenger ship or the like, if the internal combustion engine is elastically supported relative to the hull for vibration isolation, influence of the couple caused by the unbalanced force largely acts so that large vibration of the internal combustion engine appears, and pipings, etc, connected to the internal combustion engine are liable to be damaged. Hence, realization of such an internal combustion engine as has less vibration by the angle of the crank throw arrangement that satisfies the mentioned non-linear optimization condition has been long desired.

However, it is not always easy to provide an internal combustion engine having such an unequally spaced crank arrangement as meets the non-linear optimization condition.

### SUMMARY OF THE INVENTION

It is an object of the present invention to provide a practical method for determining an angle of a crank throw arrangement in a multi-cylinder reciprocating internal combustion engine by which unbalanced couple acting as vibrating force can be minimized as follows:

Where;

M₍ₖ₎ is an unbalanced couple of order k that is expressed in the form that an unbalanced force of each cylinder in the engine is weighted by distance between each cylinder and added together and is represented by;

M₍ₖ₎=FₖL[s₁ s₂ . . . sₙ][exp(ik·α₁)exp(ik·α₂) . . . exp(ik·αₙ)]^{t}=FₖL·fₖ and

fₖ is a non-dimensional coefficient in the above M₍ₖ₎ and is represented by;

fₖ={[s₁ s₂ . . . sₙ][exp(ik·α₁)exp(ik·α₂) . . . exp(ik·αₙ)]^{t}};

an angle of the crank throw arrangement αⱼ (ignition interval) that can minimize the non-dimensional coefficient fₖ is found and thereby the angle of the crank throw arrangement that can minimize the unbalanced couple acting as vibrating force is minimized.

It is also an object of the present invention to provide such an internal combustion engine as employs the angle of the crank throw arrangement determined as mentioned above, wherein the engine includes a 4-stroke cycle in-line type 7 cylinder or V-type 14 cylinder engine, a 4-stroke cycle in-line type 9 cylinder or V-type 18 cylinder engine and a 2-stroke cycle in-line type 8 cylinder engine. These engines of the V-type are such ones as have a structure in which a piston/connecting rod arrangement is provided with respect to cylinders of V-banks mutually opposing in one crank throw and the same vibrating force description can be made as in the in-line type 7 or 9 cylinder internal combustion engines.

In order to achieve the abovementioned object, the present invention provides a method for determining an angle of a crank arrangement in a multi-cylinder reciprocating internal combustion engine, comprising the steps of:

where;

F₍ₘ₎ is the sum of the unbalanced force of order m that acts as vibrating force in the multi-cylinder reciprocating internal combustion engine (having the number of crank throws of n) and is represented by;

F₍ₘ₎=Fₘ[1 1 . . . 1][exp(im·α₁)exp(im·α₂) . . . exp(im·αₙ)]^{t}=Fₘ·gₘ

(Here, m is the number or numbers of order or orders of the unbalanced force that is wanted to fall within an allowable range, for example 1 and 2, i=(−1)^{1/2} and αⱼ is an angle of the crank throw arrangement of number j, j being 1, 2, . . . , n.) and

|gₘ| is an absolute value of a non-dimensional coefficient of the unbalanced force, that is obtained by F₍ₘ₎ being divided by Fₘ, and is represented by;

|gₘ|=abs{[1 1 . . . 1][exp(im·αhd 1)exp(im·α₂) . . . exp(im·αₙ)]^{t}};

setting a restrictive condition in which both of m=1 and m=2 of |gₘ| are made zero or are endlessly approached to zero or are set to or within a finite value that is allowed by the surrounding environment where the engine is installed, and

where;

M₍ₖ₎ is an unbalanced couple that is expressed by the unbalanced force of order k of each crank throw, weighted by distance L between each cylinder, and is represented by;

M₍ₖ₎=FₖL[s₁ s₂ . . . sₙ][exp(ik·α₁)exp(ik·α₂) . . . exp(ik·αₙ)]^{t}=FₖL·fₖ

(Here, sⱼ is a non-dimensional coordinate in the crank shaft direction of the crank throw of number j.) and

|fₖ| is an absolute value of a non-dimensional coefficient of the unbalanced couple, that is obtained by M₍ₖ₎ being divided by FₖL, and is represented by;

|fₖ|=abs{[s₁ s₂ . . . sₙ][exp(ik·α₁)exp(ik·α₂) . . . exp(ik·αₙ)]^{t}};

obtaining an angle of the crank throw arrangement αⱼ by an expression on an orthogonal coordinate system, the angle of the crank throw arrangement αⱼ minimizing, under the restrictive condition, the n-th power of |fₖ|, n being an even number.

In the method for determining the angle of the crank throw arrangement according to the present invention, the abovementioned non-dimensional coefficient fₖ of the unbalanced force that acts as vibrating force may be practically based on f₁ only. This is because, if f₂ also is to be minimized at the same time, the restrictive condition becomes too severe to obtain a freedom of solution as well as because, as generally known and also as seen in the actual examples as will be described later, f₂ decreases more than in the case of the equal ignition interval or, even if it increases, it is so slight as gives substantially no influence. Hence, f₂ may be left unchecked unless it much increases as compared with the case of the equal ignition interval. It is to be noted that the same applies to the internal couple.

Also, in considering the unbalanced force and the unbalanced couple, those of the third order or higher are generally so small as may be neglected.

Also, as the abovementioned objective function f₁ itself is not appropriate for searching a solution, it is replaced with |f₁|².

Then, a sequential solution obtaining routine is carried out by means of a non-linear programming method, such as SQP method or Newton-Raphson method, and a solution can be obtained by the abovementioned method for determining the angle of the crank arrangement.

On the other hand, in the polar coordinate system according to the complex vector of exp(ik·αⱼ), formulation of simultaneous equations for obtaining αⱼ that minimizes |f₁|² is very difficult and a convergence of the repeated solution obtaining computations is often unsatisfactory to thereby invite a case where no solution is ensured. Thus, translation is made into the orthogonal coordinate system so as to obtain the angle of the crank throw arrangement that minimizes and optimizes β|f₁|^{2p}+γ|f₂|^{2q} [Here, β and γ are weighting coefficients (>0) on |f₁|^{2p} and γ|f₂|^{2q} respectively, used in minimizing and optimizing the above equation. p and q are intergers.]. Thereby, the formulation is performed and αⱼ that minimizes β|f₁|^{2p}+γ|f₂|^{2q} can be obtained. It is to be noted that, in place of |f₁|², the n-th power of |f₁|, n being an even number, such as |f₁|⁴, |f₁|⁶, etc. may be employed. Also, if a coefficient of the third order or higher is to be considered in the above equation, an equation

$${\sum }_{k}$$

βₖ|fₖ|\hat{ }(2pₖ) may be employed [Here, “\hat{ }” is a designation of power. βₖ is a weighting coefficient on |fₖ|\hat{ }(2pₖ). Pₖ is an integer.

$${\sum }_{k}$$

shows the sum up to order k.].

It is to be noted that the above described method is applicable not only to the case where the external couple is to be minimized but also to the case where the vibrating force on which the similar vibration description can be made (internal couple, vibrating force of H·X type vibration, etc.) is to be minimized.

Also, according to the present invention, as a 4-stroke cycle in-line type 7-cylinder or V-type 14 cylinder internal combustion engine or a 2-stroke cycle in-line type 8 cylinder internal combustion engine that has the unbalanced couple acting as vibration force minimized, those engines having the angles of the crank arrangement, as mentioned below, are provided. It is to be noted that the below mentioned angles are given on the basis of the most orthodox examples in which , β=1, p=1, γ=0 in the equation of β|f₁|^{2p}+γ|f₂|^{2q}. Also, as to the portion of s₁, s₂, . . . , sₙ, s₁, is set to 1 (s₁=1) and an arithmetric progression up to sₙ is employed. In this respect, the unbalanced force of the first and second orders may be first set to nearly zero, except the case where the above equation is minimized on the condition that the unbalanced force of the first or second order is set to a finite value that is allowed by the surrounding environment where the internal combustion engine is installed.

A 4-stroke cycle 7 cylinder internal combustion engine in which the angles of the crank throw arrangement of other crank throws relative to the reference crank throw are;

+100.26°±1°, −166.09°±0.5°, −112.16°±0.5°, −72.98°±0.5°, +132.89°±0.5° and +23.96°±0.5°.

Likewise, a 4-stroke cycle 7 cylinder internal combustion engine in which the angles of the crank throw arrangement of other crank throws relative to the reference crank throw are;

+99.52°±0.5°, −154.44°±0.5°, −96.46°±0.5°, +166.30°±0.5°, −44.28°±0.5° and +64.18°±0.5°.

It is to be noted that the abovementioned angles of the crank arrangement are also applicable to a 4-stroke cycle V-type 14 cylinder internal combustion engine in which a piston/connecting rod arrangement is provided with respect to cylinders of V-banks mutually opposing in one crank throw and, in this case also, the same effect to reduce the vibrating force can be obtained.

Also, according to the present invention, as a 4-stroke cycle in-line type 9 cylinder internal combustion engine that has the unbalanced couple acting as vibrating force minimized, those engines having the angles of the crank arrangement, as follows, are provided.

That is, a 4-stroke cycle 9 cylinder internal combustion engine in which the angles of the crank throw arrangement of other crank throws relative to the reference crank throw are;

+119.71°±0.5°, −158.45°±0.5°, −118.35°±0.50°, +83.19°±0.5°, −78.36°±0.5°, −36.42°±0.5°, +42.67°±0.5° and +163.67°±0.50°.

Likewise, a 4-stroke cycle 9 cylinder internal combustion engine in which the angles of the crank throw arrangement of other crank throws relative to the reference crank throw are;

+80.87°±2°, −80.73°±2°, +154.77°±2°, −155.08°±2°, −123.36°±2°, +121.73°±2°, −39.13°±2° and +37.62°±2°.

Further, a 4-stroke cycle 9 cylinder internal combustion engine in which the angles of the crank throw arrangement of other crank throws relative to the reference crank throw are;

−117.69°±3°, +82.24°±3°, +163.15°±3°, +126.45°±3°, −74.85°±3, −31.61°±3°, −152.00°±3° and +49.40°±3°.

Still further, a 4-stroke cycle 9 cylinder internal combustion engine in which the angles of the crank throw arrangement of other crank throws relative to the reference crank throw are;

−117.16°±0.5°, ±83.11°±0.5°, ±165.20°±0.5°, +120.44°±0.5°, −77.68°±0.5°, −35.46°±0.5°, −158.64°±0.5° and +44.46°±0.5°.

It is to be noted that the abovementioned angles of the crank arrangement are also applicable to a 4-stroke cycle V-type 18 cylinder internal combustion engine in which a piston/connecting rod arrangement is provided with respect to cylinders of V-banks mutually opposing in one crank throw and, in this case also, the same effect to reduce the vibrating force can be obtained.

Also, according to the present invention, as a 2-stroke cycle in-line type 8 cylinder internal combustion engine that has the unbalanced couple acting as vibrating force minimized, those engines having the angles of the crank arrangement, as follows, are provided.

That is, a 2-stroke cycle 8 cylinder internal combustion engine in which the angles of the crank throw arrangement of other crank throws relative to the reference crank throw are;

−144.71°±0.5°, +92.74°±0.5°, +129.03°±0.5°, −84.22°±0.5°, −47.94°±0.5°, −170.49°±0.5° and +44.81°±0.50°.

Likewise, a 2-stroke cycle 8 cylinder internal combustion engine in which the angles of the crank throw arrangement of other crank throws relative to the reference crank throw are;

+87.67°±0.5°, −95.70°±0.5°, +172.35°±0.5°, −132.50°±0.5°, +135.55°±0.5°, −47.82°±0.5° and +39.85°±0.5°.

Further, a 2-stroke cycle 8 cylinder internal combustion engine in which the angles of the crank throw arrangement of other crank throws relative to the reference crank throw are;

+92.80°±0.5°, −140.66°±0.5°, −83.55°±0.5°, +133.09°±0.5°, −169.79°±0.5°, −43.25°±0.5° and +49.54°±0.50°.

For each of the abovementioned crank throw arrangements, the total of the deviations shown by ± for each of the angles shall be zero.

If the multi-cylinder internal combustion engines according to the present invention are elastically supported, then an excellent effect can be obtained in reducing the influence of the couple caused by the unbalanced force.

### DESCRIPTION OF THE PREFERRED EMBODIMENTS

Herebelow, embodiments according to the method for determining the angle of the crank throw arrangement of the present invention will be concretely described based on actual examples.

### (EXAMPLE 1)

In a 4-stroke cycle 7 cylinder internal combustion engine having the ignition order set to 1-2-3-5-7-6-4, the angle of the crank throw arrangement that suppresses the unbalanced force to the least and minimizes the primary unbalanced couple is obtained. An example of the result thereof is shown in Table 1 in comparison with the case of the equal space arrangement.

As seen in Table 1, such an unequal space arrangement can be obtained that, while the coefficient of the internal couple is suppressed to the nearly same level as in the case of the equal space arrangement, the primary unbalanced couple is largely reduced.

TABLE 1

| | (a) Equal angle | (b) Unequal angle |
|---|---|---|
| Item | arrangement | arrangement |
| Angle of crank | | |
| arrangement | | |
| #1 Cylinder | 0° | 0° |
| | (0°) | (0°) |
| #2 Cylinder | 102.8571° | 100.26° |
| | (102.8571°) | (100.26°) |
| #3 Cylinder | −154.2857° | −166.09° |
| | (205.7143°) | (193.91°) |
| #4 Cylinder | −102.8571° | −112.16° |
| | (617.1429°) | (607.84°) |
| #5 Cylinder | −51.4286° | −72.98° |
| | (308.5714°) | (287.02°) |
| #6 Cylinder | 154.2857° | 132.89° |
| | (514.2857°) | (492.89°) |
| #7 Cylinder | 51.4286° | 23.96° |
| | (411.4286°) | (383.96°) |
| Coefficient of | 0 | 0.000001 |
| unbalanced | | |
| force (primary) | | |
| Coefficient of | 0 | 0.000004 |
| unbalanced | | |
| force (secondary) | | |
| Coefficient of | 1.327948 | 0.000047 |
| unbalanccd | | |
| couple (primary) | | |
| Coefficient of | 1.538871 | 0.981520 |
| unbalanced | | |
| couple (secondary) | | |
| Coefficient of | | |
| interal couple | 2.295961 | 2.404888 |
| Arrangement of ignition order Ignition order 1-2-3-5-7-6-4 | 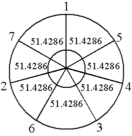 | 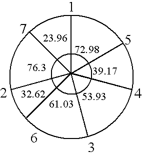 |

### (EXAMPLE 2)

In a 4-stroke cycle 7 cylinder internal combustion engine having the ignition order set to 1-2-3-6-7-5-4, the angle of the crank throw arrangement that suppresses the unbalanced force to the least and minimizes the primary unbalanced couple is obtained. An example of the result thereof is shown in Table 2 in comparison with the case of the equal space arrangement.

As seen in Table 2, such an unequal space arrangement can be obtained that, while the coefficient of the internal couple is suppressed to the nearly same level as in the case of the equal space arrangement, the primary unbalanced couple is largely reduced.

TABLE 2

| | (a) Equal angle | (b) Unequal angle |
|---|---|---|
| Item | arrangement | arrangement |
| Angle of crank | | |
| arrangement | | |
| #1 Cylinder | 0° | 0° |
| | (0°) | (0°) |
| #2 Cylinder | 102.8571 | 99.52° |
| | (102.8571°) | (99.52°) |
| #3 Cylinder | −154.2857° | −154.44° |
| | (205.7143°) | (205.56°) |
| #4 Cylinder | −102.8571° | −96.46° |
| | (617.1429°) | (623.54°) |
| #5 Cylinder | 154.2857° | 166.30° |
| | (514.2857°) | (526.30°) |
| #6 Cylinder | −51.4286° | −44.28° |
| | (308.5714°) | (315.72°) |
| #7 Cylinder | 51.4286° | 64.18° |
| | (411.4286°) | (424.18°) |
| Coefficient of | 0 | 0.000002 |
| unbalanced | | |
| force (primary) | | |
| Coefficient of | 0 | 0.000002 |
| unbalanced | | |
| force (secondary) | | |
| Coefficient of | 0.637613 | 0.000128 |
| unbalanced | | |
| couple (primary) | | |
| Coefficient of | 2.327454 | 2.670964 |
| unbalanced | | |
| couple (secondary) | | |
| Coefficient of | 2.368684 | 2.344642 |
| internal couple | | |
| Arrangement of ignition order Ignition order 1-2-3-6-7-5-4 | 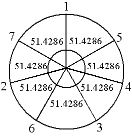 | 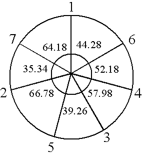 |

### (EXAMPLE 3)

In a 4-stroke cycle 9 cylinder internal combustion engine having the ignition order set to 1-5-9-4-7-8-2-3-6, the angle of the crank throw arrangement that suppresses the unbalanced force to the least and minimizes the primary unbalanced couple is obtained. An example of the result thereof is shown in Table 3 in comparison with the case of the equal space arrangement.

As seen in Table 3, such an unequal space arrangement can be obtained that, while the coefficient of the internal couple is suppressed to the nearly same level as in the case of the equal space arrangement, the primary unbalanced couple is largely reduced.

TABLE 3

| | (a) Equal angle | (b) Unequal angle |
|---|---|---|
| Item | arrangement | arrangement |
| Angle of crank | | |
| arrangement | | |
| #1 Cylinder | 0° | 0° |
| | (0°) | (0°) |
| #2 Cylinder | 120° | 119.71° |
| #2 Cylinder | (480°) | (479.71°) |
| #3 Cylinder | −160° | −158.45° |
| | (560°) | (561.55°) |
| #4 Cylinder | −120° | −118.35° |
| | (240°) | (241.65°) |
| #5 Cylinder | 80° | (83.19°) |
| | (80°) | (83.19°) |
| #6 Cylinder | −80° | −78.36° |
| | (640°) | (641.64°) |
| #7 Cylinder | −40° | −36.42° |
| | (320°) | (323.58°) |
| #8 Cylinder | 40° | 42.67° |
| | (400°) | (402.67°) |
| #9 Cylinder | 160° | 163.67° |
| | (160°) | (163.67°) |
| Coefficient of | 0 | 0.000003 |
| unbalanced | | |
| force (primary) | | |
| Coefficient of | 0 | 0.000002 |
| unbalanced | | |
| force (secondary) | | |
| Coefficient of | 0.126406 | 0.000054 |
| unbalanced | | |
| couple (primary) | | |
| Coefficient of | 1.576991 | 1.098978 |
| unbalanced | | |
| couple (secondary) | | |
| Coefficient of | | |
| internal couple | 1.770535 | 1.743647 |
| Arrangement of ignition order Ignition order 1-5-9-4-7-8-2-3-6 | 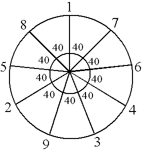 | 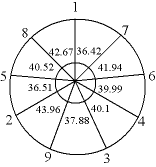 |

### (EXAMPLE 4)

In a 4-stroke cycle 9 cylinder internal combustion engine having the ignition order set to 1-2-4-6-8-9-7-5-3, the angle of the crank throw arrangement that suppresses the unbalanced force to the least and minimizes the primary unbalanced couple is obtained. An example of the result thereof is shown in Table 4 in comparison with the case of the equal space arrangement.

As seen in Table 4, such an unequal space arrangement can be obtained that, while the coefficient of the internal couple is suppressed to the nearly same level as in the case of the equal space arrangement, the primary unbalanced couple is largely reduced.

TABLE 4

| | (a) Equal angle | (b) Unequal angle |
|---|---|---|
| Item | arrangement | arrangement |
| Angle of crank | | |
| arrangement | | |
| #1 Cylinder | 0° | 0° |
| | (0°) | (0°) |
| #2 Cylinder | 80° | 80.87° |
| | (80°) | (80.87°) |
| #3 Cylinder | −80° | −80.73° |
| | (640°) | (639.27°) |
| #4 Cylinder | 160° | 154.77° |
| | (160°) | (154.77°) |
| #5 Cylinder | −160° | −155.08° |
| | (560°) | (564.92°) |
| #6 Cylinder | −120° | −123.36° |
| | (240°) | (236.64°) |
| #7 Cylinder | 120° | 121.73° |
| | (480°) | (481.73°) |
| #8 Cylinder | −40° | −39.13° |
| | (320°) | (320.87°) |
| #9 Cylinder | 40° | 37.62° |
| | (400°) | (397.62°) |
| Coefficient of | 0 | 0.000001 |
| unbalanced | | |
| force (primary) | | |
| Coefficient of | 0 | 0.000003 |
| unbalanced | | |
| force (secondary) | | |
| Coefficient of | 0.193665 | 0.000257 |
| unbalanced | | |
| couple (primary) | | |
| Coefficient of | 0.547683 | 0.692746 |
| unbalanced | | |
| couple (secondary) | | |
| Coefficient of | 4.145429 | 4.142307 |
| internal couple | | |
| Arrangement of ignition order Ignition order 1-2-4-6-8-9-7-5-3 | 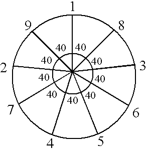 | 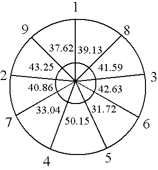 |

### (EXAMPLE 5)

In a 4-stroke cycle 9 cylinder internal combustion engine having the ignition order set to 1-3-4-2-7-9-5-8-6, the angle of the crank throw arrangement that suppresses the unbalanced force to the least and minimizes the primary unbalanced couple is obtained. An example of the result thereof is shown in Table 5 in comparison with the case of the equal space arrangement.

As seen in Table 5, such an unequal space arrangement can be obtained that, while the coefficient of the internal couple is suppressed to the nearly same level as in the case of the equal space arrangement, the primary unbalanced couple is largely reduced.

TABLE 5

| | (a) Equal angle | (b) Unequal angle |
|---|---|---|
| Item | arrangement | arrangement |
| Angle of crank | | |
| Arrangement | | |
| #1 Cylinder | 0° | 0° |
| | (0°) | (0°) |
| #2 Cylinder | −120° | −117.69° |
| | (240°) | (242.31°) |
| #3 Cylinder | 80° | 82.24° |
| | (80°) | (82.24°) |
| #4 Cylinder | 160° | 163.15° |
| | (160°) | (163.15°) |
| #5 Cylinder | 120° | 126.45° |
| | (480°) | (486.45°) |
| #6 Cylinder | −80° | −74.85° |
| | (640°) | (645.15°) |
| #7 Cylinder | −40° | −31.61° |
| | (320°) | (328.39°) |
| #8 Cylinder | −160° | −152.00° |
| | (560°) | (567.00°) |
| #9 Cylinder | 40° | 49.40° |
| | (400°) | (409.40°) |
| Coefficient of | 0 | 0.000001 |
| unbalanced | | |
| force (primary) | | |
| Coefficient of | 0 | 0.000006 |
| unbalanced | | |
| force (secondary) | | |
| Coefficient of | 0.440977 | 0.000112 |
| unbalanced | | |
| couple (primary) | | |
| Coefficient of | 1.366652 | 1.703239 |
| unbalanced | | |
| couple (secondary) | | |
| Coefficient of | 2.372107 | 2.339584 |
| internal couple | | |
| Arrangement of ignition order Ignition order 1-3-4-2-7-9-5-8-6 | 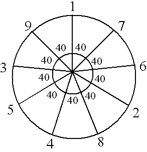 | 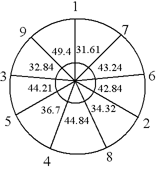 |

### (EXAMPLE 6)

In a 4-stroke cycle 9 cylinder internal combustion engine having the ignition order set to 1-3-4-2-7-9-5-8-6, the angle of the crank throw arrangement that suppresses the unbalanced force to the least and minimizes the primary unbalanced couple is obtained. An example of the result thereof is shown in Table 6 in comparison with the case of the equal space arrangement.

As seen in Table 6, such an unequal space arrangement can be obtained that, while the coefficient of the internal couple is suppressed to the nearly same level as in the case of the equal space arrangement, the primary unbalanced couple is largely reduced.

TABLE 6

| | (a) Equal angle | (b) Unequal angle |
|---|---|---|
| Item | arrangement | arrangement |
| Angle of crank | | |
| arrangement | | |
| #1 Cylinder | 0° | 0° |
| | (0°) | (0°) |
| #2 Cylinder | −120° | −117.16° |
| | (240°) | (242.84°) |
| #3 Cylinder | 80° | 83.11° |
| | (80°) | (83.11°) |
| #4 Cylinder | 160° | 165.20° |
| | (160°) | (165.20°) |
| #5 Cylinder | 120° | 120.44° |
| | (480°) | (480.44° |
| #6 Cylinder | −80° | −77.68° |
| | (640°) | (642.32°) |
| #7 Cylinder | −40° | −35.46° |
| | (320°) | (324.54°) |
| #8 Cylinder | −160° | −158.64° |
| | (560°) | (561.36°) |
| #9 Cylinder | 40° | 44.46° |
| | (400°) | (404.46°) |
| Coefficient of | 0 | 0.000435 |
| unbalanced | | |
| force (primary) | | |
| Coefficient of | 0 | 0.000922 |
| unbalanced | | |
| force (secondary) | | |
| Coefficient of | 0.440977 | 0.000054 |
| unbalanced | | |
| couple (primary) | | |
| Coefficient of | 1.366652 | 1.558243 |
| unbalanced | | |
| couple (secondary) | | |
| Coefficient of | 2.372107 | 2.342275 |
| internal couple | | |
| Arrangement of ignition order Ignition order 1-3-4-2-7-9-5-8-6 | 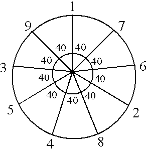 | 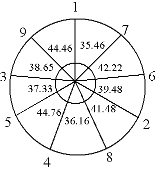 |

### (EXAMPLE 7)

In a 2-stroke cycle 8 cylinder internal combustion engine having the ignition order set to 1-8-3-4-7-2-5-6, the angle of the crank throw arrangement that suppresses the unbalanced force to the least and minimizes the primary unbalanced couple is obtained. An example of the result thereof is shown in Table 7 in comparison with the case of the equal space arrangement.

As seen in Table 7, such an unequal space arrangement can be obtained that, while the coefficient of the internal couple is suppressed to the nearly same level as in the case of the equal space arrangement, the primary unbalanced couple is largely reduced.

TABLE 7

| | (a) Equal angle | (b) Unequal angle |
|---|---|---|
| Item | arrangement | arrangement |
| Angle of crank | | |
| Arrangement | | |
| #1 Cylinder | 0° | 0° |
| | (0°) | (0°) |
| #2 Cylinder | −135° | −144.71° |
| | (225°) | (215.29°) |
| #3 Cylinder | 90° | 92.74° |
| | (90°) | (92.74°) |
| #4 Cylinder | 135° | 129.03° |
| | (135°) | (129.03°) |
| #5 Cylinder | −90° | −84.22° |
| | (270°) | (275.78°) |
| #6 Cylinder | −45° | −47.94° |
| | (315°) | (312.06°) |
| #7 Cylinder | 180° | −170.49° |
| | (180°) | (189.51°) |
| #8 Cylinder | 45° | 44.81° |
| | (45°) | (44.81°) |
| Coefficient of | 0 | 0.000001 |
| unbalanced | | |
| force (primary) | | |
| Coefficient of | 0 | 0.000003 |
| unbalanced | | |
| force (secondary) | | |
| Coefficient of | 0.896683 | 0.000065 |
| unbalanced | | |
| couple (primary) | | |
| Coefficient of | 0 | 1.405978 |
| unbalanced | | |
| couple (secondary) | | |
| Coefficient of | 1.439940 | 1.328977 |
| internal couple | | |
| Arrangement of ignition order Ignition order 1-8-3-4-7-2-5-6 | 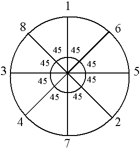 | 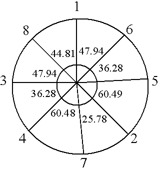 |

### (EXAMPLE 8)

In a 2 stroke cycle 8 cylinder internal combustion engine having the ignition order set to 1-8-2-6-4-5-3-7, the angle of the crank throw arrangement that suppresses the unbalanced force to the least and minimizes the primary unbalanced couple is obtained. An example of the result thereof is shown in Table 8 in comparison with the case of the equal space arrangement.

As seen in Table 8, such an unequal space arrangement can be obtained that, while the coefficient of the internal couple is suppressed to the nearly same level as in the case of the equal space arrangement, the primary unbalanced couple is largely reduced.

TABLE 8

| | (a) Equal angle | (b) Unequal angle |
|---|---|---|
| Item | arrangement | arrangement |
| Angle of crank | | |
| Arrangement | | |
| #1 Cylinder | 0° | 0° |
| | (0°) | (0°) |
| #2 Cylinder | 90° | 87.67° |
| | (90°) | (87.67°) |
| #3 Cylinder | −90° | −95.70° |
| | (270°) | (264.30°) |
| #4 Cylinder | 180° | 172.35° |
| | (180°) | (172.35°) |
| #5 Cylinder | −135° | −132.50° |
| | (225°) | (227.50°) |
| #6 Cylinder | 135° | 135.55° |
| | (135°) | (135.55°) |
| #7 Cylinder | −45° | −47.82° |
| | (315°) | (312.18°) |
| #8 Cylinder | 45° | 39.85° |
| | (45°) | (39.85°) |
| Coefficient of | 0 | 0 |
| unbalanced | | |
| force (primary) | | |
| Coefficient of | 0 | 0.000001 |
| unbalanced | | |
| force (secondary) | | |
| Coefficient of | 0.448342 | 0.000121 |
| unbalanced | | |
| couple (primary) | | |
| Coefficient of | 0 | 0.538570 |
| unbalanced | | |
| couple (secondary) | | |
| Coefficient of | 3.154485 | 3.146231 |
| internal couple | | |
| Arrangement of ignition order Ignition order 1-8-2-6-4-5-3-7 | 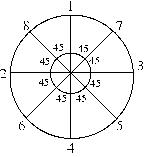 | 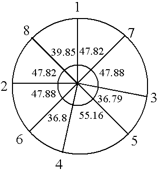 |

### (EXAMPLE 9)

In a 2-stroke cycle 8 cylinder internal combustion engine having the ignition order set to 1-8-2-5-6-3-4-7, the angle of the crank throw arrangement that suppresses the unbalanced force to the least and minimizes the primary unbalanced couple is obtained. An example of the result thereof is shown in Table 9 in comparison with the case of the equal space arrangement.

As seen in Table 9, such an unequal space arrangement can be obtained that, while the coefficient of the internal couple is suppressed to the nearly same level as in the case of the equal space arrangement, the primary unbalanced couple is largely reduced.

TABLE 9

| | (a) Equal angle | (b) Unequal angle |
|---|---|---|
| Item | arrangement | arrangement |
| Angle of crank | | |
| Arrangement | | |
| #1 Cylinder | 0° | 0° |
| | (0°) | (0°) |
| #2 Cylinder | −90° | 92.80° |
| | (90°) | (92.80°) |
| #3 Cylinder | −135° | −140.66° |
| | (225°) | (219.34°) |
| #4 Cylinder | −90° | −83.55° |
| | (270°) | (276.45°) |
| #5 Cylinder | 135° | 133.09° |
| | (135°) | (133.09°) |
| #6 Cylinder | 180° | −169.79° |
| | (180°) | (190.21°) |
| #7 Cylinder | −45° | −43.25° |
| | (315°) | (316.75°) |
| #8 Cylinder | −45° | 49.54° |
| | (45°) | 49.54°) |
| Coefficient of | 0 | 0.000001 |
| unbalanced | | |
| force (primary) | | |
| Coefficient of | 0 | 0.000001 |
| unbalanced | | |
| force (secondary) | | |
| Coefficient of | 0.131316 | 0.000065 |
| unbalanced | | |
| couple (primary) | | |
| Coefficient of | 1.414214 | 0.200722 |
| unbalanced | | |
| couple (secondary) | | |
| Coefficient of | 2.639656 | 2.528273 |
| internal couple | | |
| Arrangement of ignition order Ignition order 1-8-2-5-6-3-4-7 | 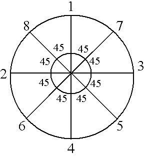 | 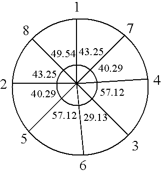 |

In the above, while the embodiments according to the present invention have been concretely described based on the actual examples, the invention is not limited to the mentioned examples but may be added with certain deviations. For example, as to the angles obtained in the Examples 1 to 3 and 6 to 9, if the deviations are within ±0.5° on these angles, a multi-cylinder internal combustion engine that has the unbalanced couple, acting as the vibrating force, reduced to a nearly satisfactory extent can be obtained.

Also, if the deviations are within ±2° on the angles obtained in the Example 4 and within ±3° on the angles obtained in the Example 5, then, respectively, a multi-cylinder internal combustion engine that has the unbalanced couple, acting as the vibrating force, reduced to a nearly satisfactory extent can be obtained.

As a summary, according to the present invention, provided is a method for determining an angle of a crank arrangement in a multi-cylinder reciprocating internal combustion engine, comprising the steps of:

where;

Fⱼ is an unbalanced force of order m of each cylinder in the multi-cylinder reciprocating internal combustion engine (having the number of crank throws of n) and is represented by;

Fⱼ=Fₘ·exp(iₘαⱼ)

(Here, Fₘ is a size of the unbalanced force of order m, i=(−1)^{1/2} and αⱼ is an angle of the crank throw of number j, j being 1, 2, . . . , n.),

F₍ₘ₎ is the sum of the unbalanced force of order m that acts as vibrating force and is represented by;

F₍ₘ₎=Fₘ[1 1 . . . 1][exp(im·α₁)exp(im·α₂) . . . exp(im·αₙ)]^{t}=Fₘ·gₘ

(Here, m is the number or numbers of order or orders of the unbalanced force that is wanted to fall within an allowable range, for example 1 and 2, and t is a designation of a turned matrix.) and

|gₘ| is an absolute value of a non-dimensional coefficient of the unbalanced force, that is obtained by F₍ₘ₎ being divided by F₍ₘ₎, and is represented by;

|gₘ|=abs{[1 1 . . . 1][exp(im·α₁)exp(im·α₂) . . . exp(im·αₙ)]^{t}};

setting a restrictive condition in which |gₘ| is made zero or is endlessly approached to zero or is set to or within a finite value that is allowed by the surrounding environment where the engine is installed, and

where;

M₍ₖ₎ is an unbalanced couple that is expressed by the unbalanced force of order k of each crank throw, weighted by distance L between each cylinder, and is represented by;

M₍ₖ₎=FₖL[s₁ s₂ . . . sₙ][exp(ik·α₁)exp(ik·α₂) . . . exp(ik·αₙ)]^{t}=FₖL·fₖ

(Here, sⱼ is a non-dimensional coordinate in the crank shaft direction of the crank throw of number j. If the crank throw of number j is the reference crank throw, sⱼ=0.) and

|fₖ| is an absolute value of a non-dimensional coefficient of the unbalanced couple, that is obtained by M₍ₖ₎ being divided by FₖL, and is represented by;

|fₖ|=abs{[s₁ s₂ . . . sₙ][exp(ik·α₁)exp(ik·α₂) . . . exp(ik·αₙ)]^{t}};

obtaining an angle of the crank throw arrangement αⱼ by an expression on an orthogonal coordinate system, the angle of the crank throw arrangement αⱼ minimizing, under the restrictive condition, the n-th power of |fₖ|, n being an even number, or the sum of the n-th power of |fₖ| that is weight.

In the present invention, in the unequally spaced crank arrangement in which the unbalanced force F₍ₘ₎ (vector) does not generally become zero, such a condition is set that the unbalanced force and the internal couple fall within an allowable range in the environment where the engine is used. Then, where |fₖ| is an absolute value of the coefficient (non-dimensional) of the unbalanced couple that is not dependent on the engine specification and is represented by;

|fₖ|=abs{[s₁ s₂ . . . sₙ][exp(ik·α₁)exp(ik·α₂) . . . exp(ik·αₙ)]^{t}},

formulation is made so as to obtain a solution as a matter of non-linear optimization problem by minimizing the n-th power of |fₖ|, n being an even number, or minimizing the sum of the n-th power of |fₖ| that is weighted. The solution is obtained on the orthogonal coordinate system and the optimal angles of the crank arrangement are obtained. Thereby, the unbalanced couple that acts as vibrating force can be reduced and the mentioned non-linear optimization problem is solved with respect to the multi-cylinders of the engine so that the optimized solution can be obtained.

According to the present invention, a multi-cylinder internal combustion engine that has the unbalanced couple acting as the vibrating force minimized can be provided. It is to be noted that the method of the present invention is applicable not only to the case where the external couple is to be minimized but also to the case where the vibrating force on which the similar vibration description can be made (such as internal couple, vibrating force of H·X type vibration, etc.) is to be minimized.

What is claimed is:

1. A method for determining an angle of a crank arrangement in a multi-cylinder reciprocating internal combustion engine, comprising the steps of:
where;
Fⱼ is an unbalanced force of order m of each cylinder in the multi-cylinder reciprocating internal combustion engine (having the number of crank throws of n) and is represented by;
Fⱼ=Fₘ·exp(iₘαⱼ)
(Here, Fₘ is a size of the unbalanced force of order m, i=(−1)^{1/2} and αⱼ is an angle of the crank throw of number j, j being 1, 2, . . . ,n.), F₍ₘ₎ is the sum of the unbalanced force of order m that acts as vibrating force of the entire engine and is represented by;
F₍ₘ₎=Fₘ[1 1 . . . 1][exp(im·α₁)exp(im·α₂) . . . exp(im·αₙ)]^{t}=Fₘ·gₘ
(Here, m is the number or numbers of order or orders of the unbalanced force that is wanted to fall within an allowable range, for example 1 and 2, and t is a designation of a turned matrix.) and

|gₘ| is an absolute value of a non-dimensional coefficient of the unbalanced force, that is obtained by F₍ₘ₎ being divided by F₍ₘ₎, and is represented by;

|gₘ|=abs{[1 1 . . . 1][exp(im·α₁)exp(im·α₂) . . . exp(im·αₙ)]^{t}};
setting a restrictive condition in which |gₘ| is made zero or is endlessly approached to zero or is set to or within a finite value that is allowed by the surrounding environment where the engine is installed, and
where;
M₍ₖ₎ is an unbalanced couple that is expressed by the unbalanced force of order k of each crank throw, weighted by distance L between each cylinder, and is represented by;
M₍ₖ₎=FₖL[s₁ s₂ . . . sₙ][exp(ik·α₁)exp(ik·α₂) . . . exp(ik·αₙ)]^{t}=FₖL·fₖ
(Here, sⱼ is a non-dimensional coordinate in the crank shaft direction of the crank throw of number j.) and

|fₖ| is an absolute value of a non-dimensional coefficient of the unbalanced couple, that is obtained by M₍ₖ₎ being divided by FₖL, and is represented by;

|fₖ|=abs{[s₁ s₂ . . . sₙ][exp(ik·α₁)exp(ik·α₂) . . . exp(ik·αₙ)]^{t}};
obtaining an angle of the crank throw arrangement αⱼ by an expression on an orthogonal coordinate system, said angle of the crank throw arrangement αⱼ minimizing, under said restrictive condition, the n-th power of |fₖ|, n being an even number.

2. A method for determining an angle of a crank arrangement in a multi-cylinder reciprocating internal combustion engine, comprising the steps of:
where;
Fⱼ is an unbalanced force of order m of each cylinder in the multi-cylinder reciprocating internal combustion engine (having the number of crank throws of n) and is represented by;
Fⱼ=Fₘ·exp(iₘαj)
(Here, Fₘ is a size of the unbalanced force of order m, i=(−1)^{1/2} and αⱼ is an angle of the crank throw of number j, j being 1, 2, . . . , n.),
F₍ₘ₎ is the sum of the unbalanced force of order m that acts as vibrating force of the entire engine and is represented by;
F₍ₘ₎=Fₘ[1 1 . . . 1][exp(im·α₁)exp(im·α₂) . . . exp(im·αₙ)]^{t}=Fₘ·gₘ
(Here, m is the number or numbers of order or orders of the unbalanced force that is wanted to fall within an allowable range, for example 1 and 2, and t is a designation of a turned matrix.) and

|gₘ| is an absolute value of a non-dimensional coefficient of the unbalanced force, that is obtained by F₍ₘ₎ being divided by Fₘ, and is represented by;

|gₘ|=abs{[1 1 . . . 1][exp(im·α₁)exp(im·α₂) . . . exp(im·αₙ)]^{t}};
setting a restrictive condition in which |gₘ| is made zero or is endlessly approached to zero or is set to or within a finite value that is allowed by the surrounding environment where the engine is installed, and
where;
M₍ₖ₎ is an unbalanced couple that is expressed by the unbalanced force of order k of each crank throw, weighted by distance L between each cylinder, and is represented by;
M₍ₖ₎=FₖL[s₁ s₂ . . . sₙ][exp(ik·α₁)exp(ik·α₂) . . . exp(ik·αₙ)]^{t}=FₖL·fₖ
(Here, sⱼ is a non-dimensional coordinate in the crank shaft direction of the crank throw of number j.)

|fₖ| is an absolute value of a non-dimensional coefficient of the unbalanced couple, that is obtained by M₍ₖ₎ being divided by FₖL, and is represented by;

|fₖ|=abs{[s₁ s₂ . . . sₙ][exp(ik·α₁)exp(ik·α₂) . . . exp(ik·αₙ)]^{t}} and
the sum of the n-th power of |fₖ|, n being an even number, said n-th power of |fₖ| being weighted, is represented by;
$${\sum }_{k} {β}_{k} \vert {f}_{k} \vert ⋀ ( 2 {p}_{k} )$$
(Here, “\hat{ }” is a designation of power, β is a weighting coefficient of order k.
Pₖ, being an integer, is a power of order k.);
obtaining an angle of the crank throw arrangement αⱼ by an expression on an orthogonal coordinate system, said angle of the crank throw arrangement αⱼ minimizing, under said restrictive condition, said sum
$${\sum }_{k} {β}_{k} \vert {f}_{k} \vert ⋀ ( 2 {p}_{k} ) .$$

3. A 4-stroke cycle in-line type 7 cylinder or V-type 14 cylinder internal combustion engine, wherein, where a crank throw of a front end or a rear end of a crank shaft is defined a reference crank throw, angles of the crank throw arrangement of other crank throws relative to the reference crank throw are set to +100.26°±1°, −166.09°±0.5°, −112.16°±0.5°, −72.98°±0.5°, +132.89°±0.5° and +23.96°±0.5° in the order counted from the reference crank throw, provided that the total of the deviations shown by ± relative to each of said angles shall be zero.

4. A 4-stroke cycle in-line type 7 cylinder or V-type 14 cylinder internal combustion engine, wherein, where a crank throw of a front end or a rear end of a crank shaft is defined a reference crank throw, angles of the crank throw arrangement of other crank throws relative to the reference crank throw are set to +99.52°±0.5°, −154.44°±0.5°, −96.46°±0.5°, +166.30°±0.5°, −44.28°±0.5° and +64.18°±0.5° in the order counted from the reference crank throw, provided that the total of the deviations shown by ± relative to each of said angles shall be zero.

5. A 4-stroke cycle in-line type 9 cylinder or V-type 18 cylinder internal combustion engine, wherein, where a crank throw of a front end or a rear end of a crank shaft is defined a reference crank throw, angles of the crank throw arrangement of other crank throws relative to the reference crank throw are set to +119.71°±0.5°, −158.45°±0.5°, −118.35°±0.5°, +83.19°±0.5°, −78.36°±0.5°, −36.42°±0.5°, +42.67°±0.5° and +163.67°±0.5° in the order counted from the reference crank throw, provided that the total of the deviations shown by ± relative to each of said angles shall be zero.

6. A 4-stroke cycle in-line type 9 cylinder or V-type 18 cylinder internal combustion engine, wherein, where a crank throw of a front end or a rear end of a crank shaft is defined a reference crank throw, angles of the crank throw arrangement of other crank throws relative to the reference crank throw are set to +80.87°±2°, −80.73°±2°, +154.77°±2°, −155.08°±2°, −123.36°±2°, +121.73°±2°, −39.13°±2° and +37.62°±2° in the order counted from the reference crank throw, provided that the total of the deviations shown by ± relative to each of said angles shall be zero.

7. A 4-stroke cycle in-line type 9 cylinder or V-type 18 cylinder internal combustion engine, wherein, where a crank throw of a front end or a rear end of a crank shaft is defined a reference crank throw, angles of the crank throw arrangement of other crank throws relative to the reference crank throw are set to −117.69°±3°, +82.24°±3°, +163.15°±3°, +126.45°±3°, −74.85°±3, −31.61°±3°, −152.00°±3° and +49.40°±3° in the order counted from the reference crank throw, provided that the total of the deviations shown by ± relative to each of said angles shall be zero.

8. A 4-stroke cycle in-line type 9 cylinder or V-type 18 cylinder internal combustion engine, wherein, where a crank throw of a front end or a rear end of a crank shaft is defined a reference crank throw, angles of the crank throw arrangement of other crank throws relative to the reference crank throw are set to −117.16°±0.5°, +83.11°±0.5°, +165.20°±0.5°, +120.44°±0.5°, −77.68°±0.5°, −35.46°±0.5°, −158.64°±0.5° and +44.46°±0.5° in the order counted from the reference crank throw, provided that the total of the deviations shown by ± relative to each of said angles shall be zero.

9. A 2-stroke cycle in-line type 8 cylinder internal combustion engine, wherein, where a crank throw of a front end or a rear end of a crank shaft is defined a reference crank throw, the angles of the crank throw arrangement of other crank throws relative to the reference crank throw are set to −144.71°±0.5°, +92.74°±0.5°, +129.03°±0.5°, −84.22°±0.5°, −47.94°±0.5°, −170.49°±0.5° and +44.81°±0.5° in the order counted from the reference crank throw, provided that the total of the deviations shown by ±relative to each of said angles shall be zero.

10. A 2-stroke cycle in-line type 8 cylinder internal combustion engine, wherein, where a crank throw of a front end or a rear end of a crank shaft is defined a reference crank throw, the angles of the crank throw arrangement of other crank throws relative to the reference crank throw are set to +87.67°±0.5°, −95.70°±0.5°, +172.35°±0.5°, −132.50°±0.5°, +135.55°±0.5°, −47.82°±0.5° and +39.85°±0.5° in the order counted from the reference crank throw, provided that the total of the deviations shown by ± relative to each of said angles shall be zero.

11. A 2-stroke cycle in-line type 8 cylinder internal combustion engine, wherein, where a crank throw of a front end or a rear end of a crank shaft is defined a reference crank throw, the angles of the crank throw arrangement of other crank throws relative to the reference crank throw are set to +92.80°±0.5°, −140.66°±0.5°, −83.55°±0.5°, +133.09°±0.5°, −169.79°±0.5°, −43.25°±0.5° and +49.54°±0.5° in the order counted from the reference crank throw, provided that the total of the deviations shown by ± relative to each of said angles shall be zero.

12. A 4-stroke cycle in-line type 7 cylinder or V-type 14 cylinder internal combustion engine as claimed in claim 3 or 4, being elastically supported relative to a support structure of said engine.

13. A 4-stroke cycle in-line type 9 cylinder or V-type 18 cylinder internal combustion engine as claimed in any one of claims 5 to 8, being elastically supported to a support structure of said engine.

14. A 2-stroke cycle in-line type 8 cylinder internal combustion engine as claimed in any one of claims 9 to 11, being elastically supported to a support structure of said engine.
